(19) United States
(12) Patent Application Publication
(10) Pub. No.: US 2004/0004708 A1
(43) Pub. Date: Jan. 8, 2004

(54) Method and system for data handling, storage and manipulation

(75) Inventor: James Willis, Lakeway, TX (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 10/447,228

(22) Filed: May 29, 2003

Related U.S. Application Data
(60) Provisional application No. 60/383,612, filed on May 29, 2002.

(51) Int. Cl. G01N 21/00

(52) U.S. Cl. 356/72

(57) ABSTRACT

The present invention provides for an improved data collection system comprising a measurement device and a controller, wherein the controller provides at least one algorithm for data handling, storage and manipulation. The present invention further provides for an improved method of data handling, storage and manipulation comprising the steps of: measuring a first set of data using a measurement device coupled to a process reactor, producing a first set of reduced data using a peak extraction algorithm executed on a controller coupled to the measurement device, wherein the first set of reduced data comprises a data volume equal to or less than a data volume of the first set of data. In an alternate embodiment of the present invention a first reduced data set and a second reduced data set can be determined, compared and correlated with a state of the plasma processing system. The state of the plasma processing system can include an endpoint condition or a fault condition.

### CROSS-REFERENCE TO RELATED APPLICATIONS

The present invention claims the benefit of U.S. Provisional Application No. 60/383,612, filed May 29, 2002, the entire contents of which are herein incorporated by reference.

### FIELD OF THE INVENTION

The present invention relates to data collection and more particularly to a data collection system and method for data handling, storage and manipulation in a data collection system.

### BACKGROUND OF THE INVENTION

The fabrication of integrated circuits (IC) in the semiconductor industry typically employs plasma to create and assist surface chemistry within a plasma reactor necessary to remove material from and deposit material to a substrate. In general, plasma is formed within the plasma reactor under vacuum conditions by heating electrons to energies sufficient to sustain ionizing collisions with a supplied process gas. Moreover, the heated electrons can have energy sufficient to sustain dissociative collisions and, therefore, a specific set of gases under predetermined conditions (e.g., chamber pressure, gas flow rate, etc.) are chosen to produce a population of charged species and chemically reactive species suitable to the particular process being performed within the chamber (e.g., etching processes where materials are removed from the substrate or deposition processes where materials are added to the substrate).

Typically, during plasma processing such as for example during etch applications, various diagnostic techniques such as, for example, optical emission spectroscopy (OES), radio frequency (RF) voltage/current/impedance measurements, RF harmonic (voltage/current) measurements, etc., are utilized to provide methods for characterizing the state of a plasma processing system, controlling the plasma processing system, detecting faults in the plasma processing system and, for instance, detecting the etch endpoint in a plasma processing system. In general, as IC device size continues to shrink, the amount of data required to sensitively characterize these systems has tended to increase.

As an example, OES data presents a challenging problem for data handling, storage and manipulation. The required data collection rate for OES data can be as great as, for instance, 6000 channels (or wavelengths) at a rate of ten (10) samples per second. However, the actual information content of the OES spectrum is significantly less than the OES sensor implementation dependent 6000 channels. Moreover, the data collection rate of ten (10) times per second is required only for endpoint detection rather than for wafer level process control.

### SUMMARY OF THE INVENTION

The present invention provides for an improved data collection system comprising a measurement device and a controller, wherein the controller provides at least one algorithm for data handling, storage, and manipulation.

The present invention further provides for an improved method of data handling, storage, and manipulation comprising the steps of: measuring a first set of data using a measurement device coupled to a process reactor, producing a first set of reduced data using a peak extraction algorithm executed on a controller coupled to the measurement device, wherein the first set of reduced data comprises a data volume equal to or less than a data volume of the first set of data.

It is a further object of the present invention to provide an additional improved method for data handling, storage, and manipulation comprising the steps of: measuring a second set of data using the measurement device coupled to the process reactor, producing a second set of reduced data using the peak extraction algorithm executed on the controller coupled to the measurement device, wherein the second set of reduced data comprises a data volume equal to or less than a data volume of the second set of data.

It is a further object of the present invention to provide an additional improved method of data handling, storage, and manipulation for a plasma processing system comprising the steps of: comparing the first set of reduced data with the second set of reduced data, and correlating the comparing of the first set of reduced data and the second set of reduced data with a state of the plasma processing system.

It is a further object of the present invention to provide an improved plasma processing system comprising a process reactor and a data collection system, the data collection system comprises a measurement device and a controller, wherein the controller provides at least one algorithm for data handling, storage and manipulation.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 shows a plasma processing system according to a preferred embodiment of the present invention;

FIG. 2 shows a plasma processing system according to an alternate embodiment of the present invention;

FIG. 3 shows a plasma processing system according to another embodiment of the present invention;

FIG. 4 shows a plasma processing system according to another embodiment of the present invention;

FIG. 5 shows a plasma processing system according to an additional embodiment of the present invention;

FIG. 6 presents a typical optical emission spectrum from a plasma etch process;

FIG. 7 shows a typical measured optical emission spectrum indicating the measured linewidth;

FIG. 8 shows the zero crossing of the first derivative of a spectral peak as presented in FIG. 9;

FIG. 9 shows the zero crossings of the second derivative of a spectral peak as presented in FIG. 9;

FIG. 10 presents a table illustrating a typical set of reduced data from a plasma process;

FIG. 11 presents an additional table illustrating a typical set of reduced data from a plasma process;

FIG. 12 presents a typical RF spectrum from an electrical measurement in a plasma processing system;

FIG. 13 presents a method of improved data handling, storage and manipulation according to an embodiment of the present invention;

FIG. 14 presents another method of improved data handling, storage and manipulation according to an embodiment of the present invention; and

FIG. 15 presents another method of improved data handling, storage and manipulation according to an embodiment of the present invention.

### DETAILED DESCRIPTION OF AN EMBODIMENT

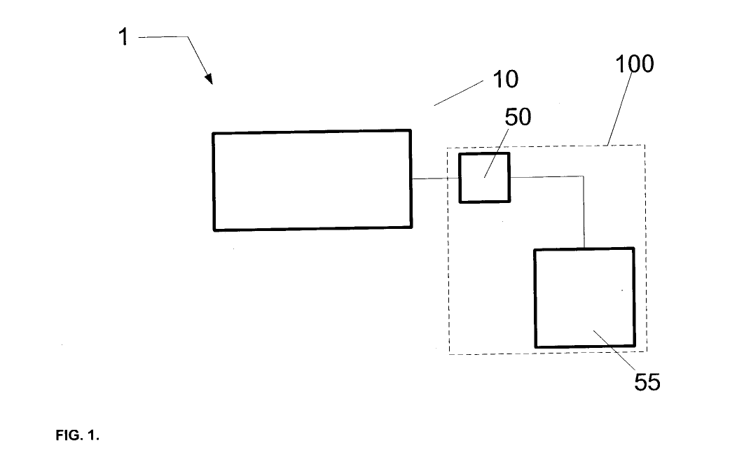

According to an embodiment of the present invention, a plasma processing system 1 is depicted in FIG. 1 comprising a process reactor 10 and a data collection system 100, wherein the data collection system 100 comprises a measurement device 50 and a controller 55. The measurement device 50 is coupled to the process reactor 10 and the controller 55 is coupled to the measurement device 52 for measuring a signal related to the performance of the process reactor 10. Moreover, the controller 55 is capable of executing an algorithm for improved data handling, storage and manipulation.

In the illustrated embodiment, plasma processing system 1, depicted in FIG. 1, utilizes a plasma for material processing. Desirably, plasma processing system 1 comprises an etch chamber. Alternately, plasma processing system 1 comprises a deposition chamber such as, for example, a chemical vapor deposition (CVD) system or a physical vapor deposition (PVD) system.

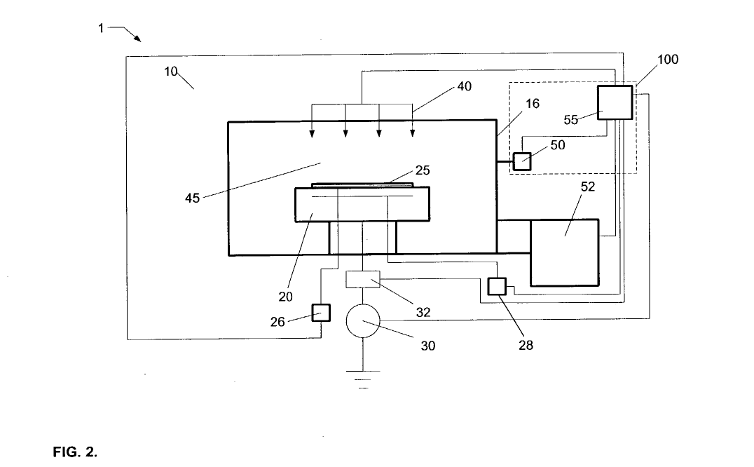

According to the illustrated embodiment of the present invention depicted in FIG. 2, plasma processing system 1 can comprise process reactor 10 with process chamber 16, substrate holder 20, upon which a substrate 25 to be processed is affixed, gas injection system 40, and vacuum pumping system 52. Substrate 25 can be, for example, a semiconductor substrate, a wafer, or a liquid crystal display (LCD). Process chamber 16 can be, for example, configured to facilitate the generation of plasma in processing region 45 adjacent a surface of substrate 25, wherein plasma is formed via collisions between heated electrons and an ionizable gas. An ionizable gas or mixture of gases is introduced via gas injection system 40, and the process pressure is adjusted. For example, a controller 55 can be used to adjust the vacuum pumping system 52. Desirably, plasma is utilized to create materials specific to a pre-determined materials process, and to aid either the deposition of material to substrate 25 or the removal of material from the exposed surfaces of substrate 25.

Substrate 25 can be, for example, transferred into and out of process chamber 16 through a slot valve (not shown) and chamber feed-through (not shown) via robotic substrate transfer system where it is received by substrate lift pins (not shown) housed within substrate holder 20 and mechanically translated by devices housed therein. Once substrate 25 is received from substrate transfer system, it is lowered to an upper surface of substrate holder 20.

Desirably, the substrate 25 can be, for example, affixed to the substrate holder 20 via an electrostatic clamping system 28. Furthermore, substrate holder 20 can further include a cooling system including a recirculating coolant flow that receives heat from substrate holder 20 and transfers heat to a heat exchanger system (not shown), or when heating, transfers heat from the heat exchanger system. Moreover, gas can be delivered to the back-side of the substrate via a backside gas system 26 to improve the gas-gap thermal conductance between substrate 25 and substrate holder 20. Such a system can be utilized when temperature control of the substrate is required at elevated or reduced temperatures. For example, temperature control of the substrate can be useful at temperatures in excess of the steady-state temperature achieved due to a balance of the heat flux delivered to the substrate 25 from the plasma and the heat flux removed from substrate 25 by conduction to the substrate holder 20. In other embodiments, heating elements, such as resistive heating elements, or thermo-electric heaters/coolers can be included.

In the illustrated embodiment, shown in FIG. 2, substrate holder 20 can comprise an electrode through which RF power is coupled to plasma in processing region 45. For example, substrate holder 20 can be electrically biased at a RF voltage via the transmission of RF power from RF generator 30 through impedance match network 32 to substrate holder 20. The RF bias can serve to heat electrons to form and maintain plasma. In this configuration, the system can operate as a reactive ion etch (RIE) reactor, wherein the chamber and upper gas injection electrode serve as ground surfaces. A typical frequency for the RF bias can range from 1 MHz to 100 MHz and is preferably 13.56 MHz. RF systems for plasma processing are well known to those skilled in the art.

Alternately, RF power can be applied to the substrate holder electrode at multiple frequencies. Furthermore, impedance match network 32 serves to maximize the transfer of RF power to plasma in processing chamber 10 by minimizing the reflected power. Match network topologies (e.g. L-type, π-type, T-type, etc.) and automatic control methods are well known to those skilled in the art.

With continuing reference to FIG. 2, process gas can be, for example, introduced to processing region 45 through gas injection system 40. Process gas can, for example, comprise a mixture of gases such as argon, CF₄ and O₂, or argon, C₄F₈ and O₂ for oxide etch applications, or other chemistries such as, for example, O₂/CO/Ar/C₄F₈, O₂/CO/AR/C₅F₈, O₂/CO/Ar/C₄F₆, O₂/Ar/C₄F₆, N₂/H₂. Gas injection system 40 can comprise a showerhead, wherein process gas is supplied from a gas delivery system (not shown) to the processing region 45 through a gas injection plenum (not shown), a series of baffle plates (not shown) and a multi-orifice showerhead gas injection plate (not shown). Gas injection systems are well known to those of skill in the art.

As described in FIG. 1 and again shown in FIG. 2, data collection system 100 is coupled to process chamber 16 to monitor a performance of the plasma processing system 1. Data collection system 100 comprises controller 55 and measurement device 50, which can be a light detection device for monitoring the light emitted from the plasma in processing region 45.

Measurement device 50 can include a detector such as a (silicon) photodiode or a photomultiplier tube (PMT) for measuring the total light intensity emitted from the plasma. It can further comprise an optical filter such as a narrow-band interference filter. In an alternate embodiment, measurement device 50 can comprise a line CCD (charge coupled device) or CID (charge injection device) array and a light dispersing device such as a grating or a prism. Additionally, measurement device 50 can comprise a monochromator (e.g. grating/detector system) for measuring light at a given wavelength, or a spectrometer (e.g. with a rotating grating) for measuring the light spectrum such as, for example, the device described in U.S. Pat. No. 5,888,337.

For example, measurement device 50 can comprise a high resolution OES sensor from Peak Sensor Systems or Verity Instruments, Inc. Such an OES sensor has a broad spectrum that spans the ultraviolet (UV), visible (VIS) and near infrared (NIR) light spectrums. The resolution is approximately 1.4 Angstroms, that is, the sensor is capable of collecting 5550 wavelengths from 240 to 1000 nm. The sensor is equipped with high sensitivity miniature fiber optic UV-VIS-NIR spectrometers which are, in turn, integrated with 2048 pixel linear CCD arrays.

The spectrometers receive light transmitted through single and bundled optical fibers, where the light output from the optical fibers is dispersed across the line CCD array using a fixed grating. Similar to the configuration described above, light emitting through an optical vacuum window is focused onto the input end of the optical fibers via a convex spherical lens. Three spectrometers, each specifically tuned for a given spectral range (UV, VIS and NIR), form a sensor for a process chamber. Each spectrometer includes an independent A/D converter. And lastly, depending upon the sensor utilization, a full emission spectrum can be recorded every 0.1 to 1.0 seconds.

Alternately, measurement device 50 can comprise an electrical measurement device such as a current and/or voltage probe for monitoring an electrical property of the electrical system comprising the processing region 45, a power meter, or spectrum analyzer. For example, plasma processing systems often employ RF power to form plasma, in which case, a RF transmission line, such as, for instance, a coaxial cable or structure, is employed to couple RF energy to the plasma through an electrical coupling element (i.e. inductive coil, electrode, etc.). Electrical measurements using, for example, a current-voltage probe, can be exercised anywhere within the electrical (RF) circuit, such as within a RF transmission line. Furthermore, the measurement of an electrical signal, such as a time trace of voltage or current, permits the transformation of the signal into frequency space using discrete Fourier series representation (assuming a periodic signal). Thereafter, the Fourier spectrum (or for a time varying signal, the frequency spectrum) can be monitored and analyzed to characterize the state of plasma processing system 1. A voltage-current probe can be, for example, a device as described in detail in pending U.S. application Ser. No. 60/259,862 filed on Jan. 8, 2001, and U.S. Pat. No. 5,467,013 issued to Sematech, Inc. on Nov. 14, 1995; each of which is incorporated herein by reference in its entirety.

In alternate embodiments, measurement device 50 can comprise a broadband RF antenna useful for measuring a radiated RF field external to plasma processing system 1. A commercially available broadband RF antenna is a broadband antenna such as Antenna Research Model RAM-220 (0.1 MHz to 300 MHz).

Vacuum pump system 52 can, for example, include a turbo-molecular vacuum pump (TMP) capable of a pumping speed up to 5000 liters per second (and greater) and a gate valve for throttling the chamber pressure. In conventional plasma processing devices utilized for dry plasma etch, a 1000 to 3000 liter per second TMP is generally employed. TMPs are useful for low pressure processing, typically less than 50 mTorr. At higher pressures, the TMP pumping speed falls off dramatically. For high pressure processing (i.e. greater than 100 mTorr), a mechanical booster pump and dry roughing pump can be used. Furthermore, a device for monitoring chamber pressure (not shown) is coupled to the process chamber 16. The pressure measuring device can be, for example, a Type 628B Baratron absolute capacitance manometer commercially available from MKS Instruments, Inc. (Andover, Mass.).

Controller 55 comprises a microprocessor, memory, and a digital I/O port capable of generating control voltages sufficient to communicate and activate inputs to plasma processing system 1 as well as monitor outputs from plasma processing system 1. Moreover, controller 55 is coupled to and exchanges information with RF generator 30, impedance match network 32, gas injection system 40, vacuum pump system 52, backside gas delivery system 26, electrostatic clamping system 28, and measurement device 50. A program stored in the memory is utilized to activate the inputs to the aforementioned components of a plasma processing system 1 according to a stored process recipe. One example of controller 55 is a DELL PRECISION WORKSTATION 610™, available from Dell Corporation, Austin, Tex.

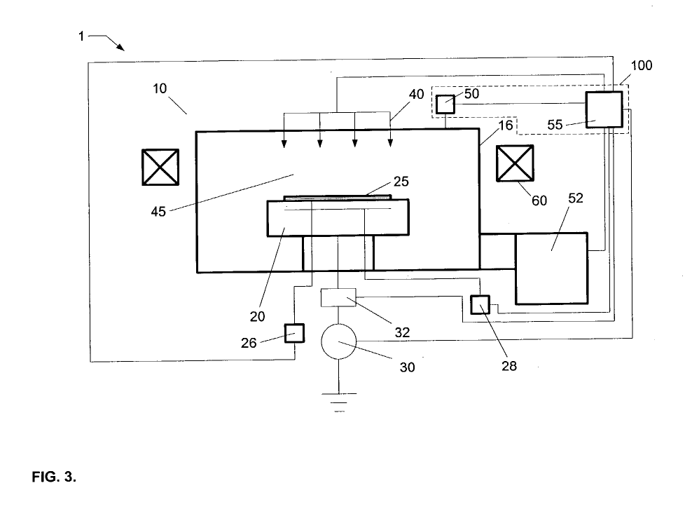

As shown in FIG. 3, plasma processing system 1 can comprise magnetic field system 60. For example, magnetic field system 60 can include a stationary or either a mechanically or electrically rotating dc magnetic field in order to potentially increase plasma density and/or improve plasma processing uniformity. Moreover, controller 55 can be coupled to magnetic field system 60 in order to regulate the speed of rotation and field strength. The design and implementation of a rotating magnetic field is well known to those skilled in the art.

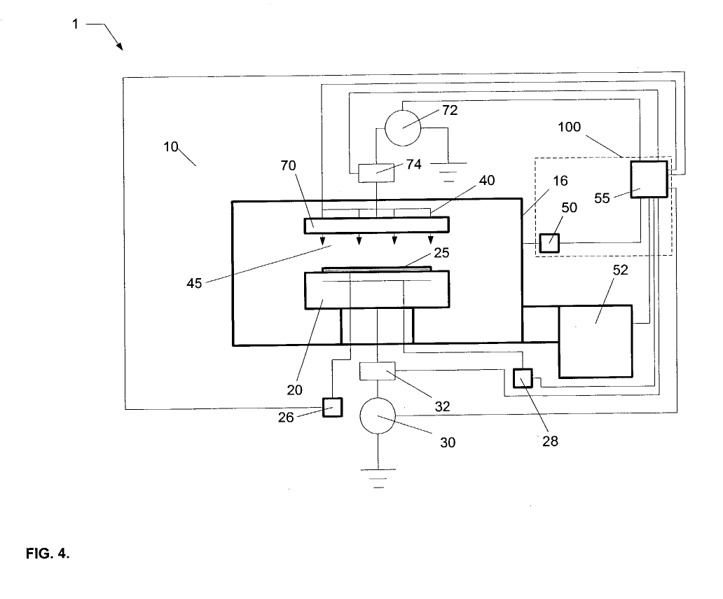

As shown in FIG. 4, the plasma processing system of FIG. 1 can comprise upper electrode 70. For example, RF power can be coupled from RF generator 72 through impedance match network 74 to upper electrode 70. A typical frequency for the application of RF power to the upper electrode can range from 10 MHz to 200 MHz and is preferably 60 MHz. Additionally, a typical frequency for the application of power to the lower electrode can range from 0.1 MHz to 30 MHz and is preferably 2 MHz. Moreover, controller 55 can be coupled to RF generator 72 and impedance match network 74 in order to control the application of RF power to upper electrode 70. The design and implementation of an upper electrode is well known to those skilled in the art.

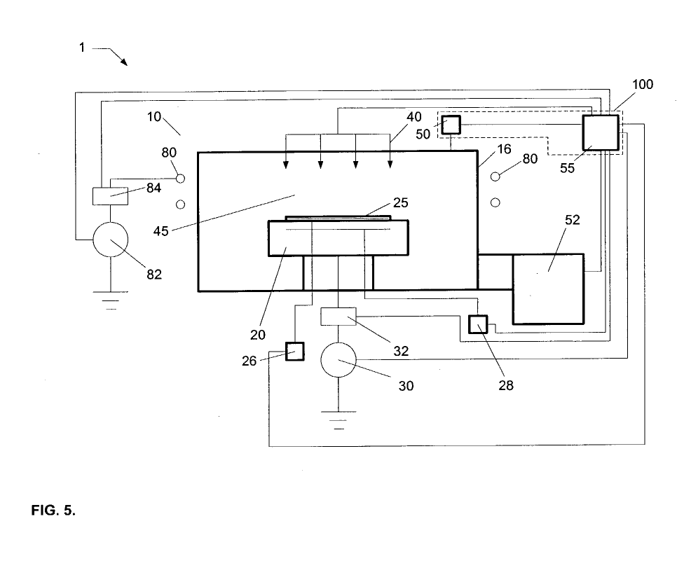

As shown in FIG. 5, the plasma processing system of FIG. 1 can comprise inductive coil 80. For example, RF power can be coupled from RF generator 82 through impedance match network 84 to inductive coil 80, and RF power can be inductively coupled from inductive coil 80 through dielectric window (not shown) to plasma processing region 45. A typical frequency for the application of RF power to the inductive coil 80 can range from 10 MHz to 100 MHz and is preferably 13.56 MHz. Similarly, a typical frequency for the application of power to the chuck electrode can range from 0.1 MHz to 30 MHz and is preferably 13.56 MHz. In addition, a slotted Faraday shield (not shown) can be employed to reduce capacitive coupling between the inductive coil 80 and plasma. Moreover, controller 55 can be coupled to RF generator 82 and impedance match network 84 in order to control the application of power to inductive coil 80. In an alternate embodiment, inductive coil 80 can be a “spiral” coil or “pancake” coil in communication with the plasma processing region from above as in a transformer coupled plasma (TCP) reactor. The design and implementation of an inductively coupled plasma (ICP) source and/or transformer coupled plasma (TCP) source is well known to those skilled in the art.

Alternately, the plasma can be formed using electron cyclotron resonance (ECR). In yet another embodiment, the plasma is formed from the launching of a Helicon wave. In yet another embodiment, the plasma is formed from a propagating surface wave. Each plasma source described above is well known to those skilled in the art.

As discussed above, data collection system 100 comprises measurement device 50 and controller 55, wherein controller 55 is capable of executing an algorithm for improved data handling, storage, and manipulation. In the following discussion, the handling, storage, and manipulation of data extracted from plasma processing system 1 is presented using optical emission spectroscopy (OES) as an example. However, the improved methods of data handling, storage and manipulation are not to be limited in scope by this exemplary presentation.

When using optical emission spectroscopy (OES), the various energies of electromagnetic radiation can be separated in space using a crystal or grating as described earlier. Gratings separate the incident light according to wavelength. The energy and wavelength of a photon is related by the formula, viz.

vλ=c, (1)

where v is the frequency, k is the wavelength and c is the speed of light. The energy of a photon is related to the frequency by the formula, viz.

E=hv, (2)

where E is the energy and h is Planck's constant. Combining equations (1) and (2) gives:

E=hc/λ.

Spectra are representations of the energy or wavelength distribution of incident light. In either case (energy or wavelength), the spectrum represents the relative number of photons occurring in the span from an energy E to E+δE, or from a wavelength of λ to λ+δλ. Therefore, the ordinate of an emission spectrum and is often labeled as Intensity (E/δE) or Intensity (λ/δλ). These representations indicate the intensity at energy E in the range from E to E+δE, or the intensity at wavelength λ in the range from λ to λ+67 λ. Conversions between the two representations can be accomplished by dividing either by the energy squared or wavelength squared, respectively.

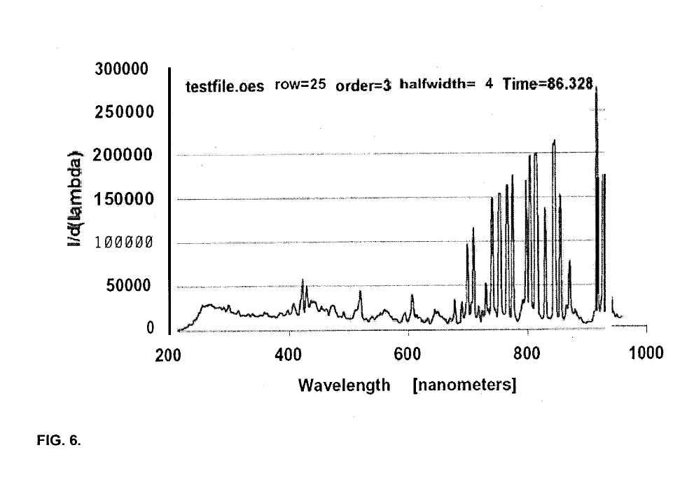

FIG. 6 presents a typical optical emission spectrum from a plasma etch process. For example, the OES spectrum from a typical plasma etch process can exhibit a slowly varying background structure covering a broad range of wavelength space. Furthermore, there can be a broad feature in the range from 250 to approximately 400 nanometers (nm). The background of the spectrum can depend upon the plasma temperature and the electron density. Moreover, there exists an additional feature at approximately 600 nm that can be useful for endpoint detection.

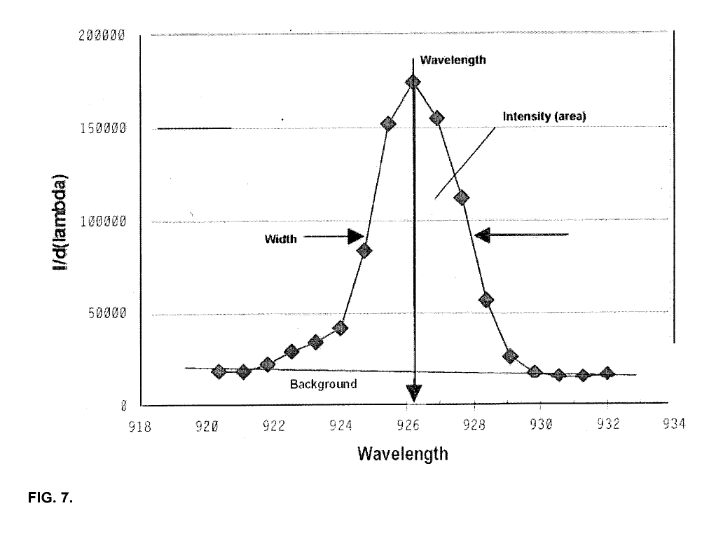

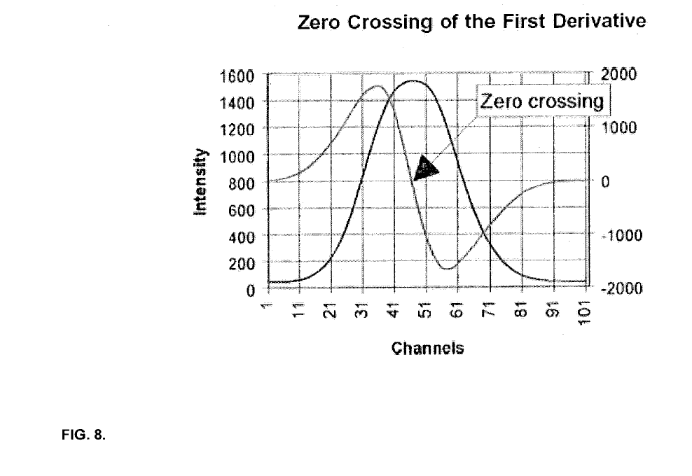

FIG. 7 shows a typical measured optical emission spectrum indicating the measured linewidth. For example, a spectral peak can be characterized by three parameters, namely, wavelength, intensity, and width. The wavelength can be defined as the position of the center of the peak in the spectrum. The center is often defined as the xₒ value of a Gaussian curve fit through the points that represent the peak. Alternatively, the center of the peak can be approximated by the zero crossing of the first derivative of the spectrum, as shown in FIG. 8. In the case of isolated Gaussian shaped peaks, the zero crossing of the first derivative occurs at the same location as the xₒ value of a Gaussian curve fit to the points. The advantage of the first derivative technique is simplicity and speed.

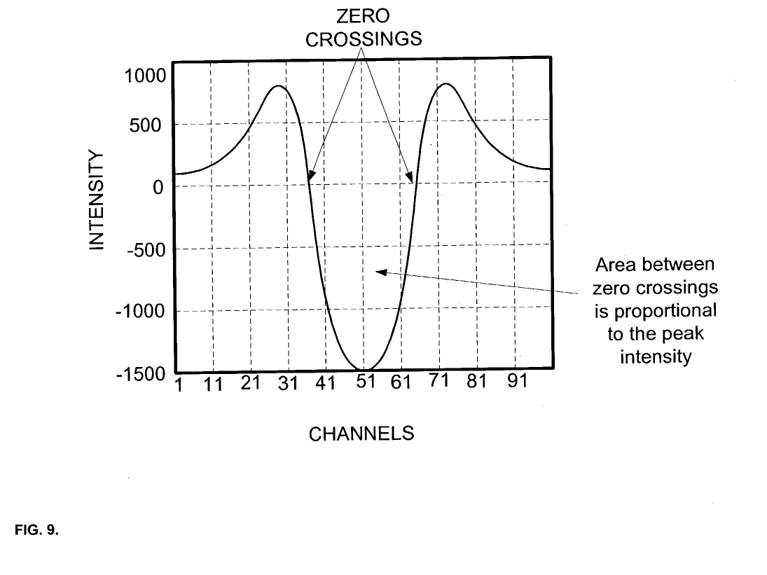

The intensity of a peak can be defined as the area under the curve from one side of the peak to the other side of the peak. A simple technique is to draw a line from one side to the other side of the peak and extract the area bounded by the peak and the line. The area above the line is the background corrected intensity and is sometimes referred to as the “net” intensity; see FIG. 7. In an alternate embodiment, the area between the zero crossings of the second derivative and above the curve is proportional to the net intensity above the background; see FIG. 9. With optimal choice of filter width, the statistics of this technique approaches the statistics of an integration over the full-width half-maximum (FWHM) region of interest.

The Savitsky-Golay (SVG) technique is widely employed for smoothing spectral data, finding peak positions and sometimes extracting the peak intensities above the background; see Savitsky, A. and Golay, M. J. 1964, Analytical Chemistry, Vol. 36, pp. 1627-1639. Additionally, this technique provides expedient calculations and offers filter coefficients that are independent of the data.

The SVG technique is based on a least squares fit of a polynomial of order n over some number of channels of data. The filter extends an equal number of channels on either side of the central point, therefore, the filter has a width which includes the number of points to the left of the central point as well as a number of points to the right of the central point. The total filter width can be expressed as 2m+1, where m is the number of channels on either side of the filtered (or calculated) point. Application of the Savitsky-Golay filter proceeds by calculating the first filtered point starting at least m+1 channels from the lower side of the spectrum, moving the filter along one channel at a time and stopping the filter m channels before the upper end of the spectrum.

The SVG filter calculates the coefficients of a polynomial expansion about the center point of the data yⱼ, viz.

yᵢ=a₀+a₁xᵢ+. . . +aₙxᵢⁿ, (3)

where i ranges from j−m to j+m, j=0, 1, . . . , n using the least squares fitting technique. It is interesting to note that the values of x are somewhat arbitrary; the only requirement is that the center point is zero. Application of the least squares fitting technique, assuming a uniform noise contribution, leads to the matrix formulation:

{\overline{x}^{T}\overline{x}}\overline{a}=\overline{x}^{T}\overline{y}, (4)

where xᵢⱼ=i^{j}, i=−m, −m+1, . . . , 0, . . . , m−1, m and j=0, 1, . . . , n. The fitted values of a₀, a₁ and a₂ are closely related to the average, the first derivative and the second derivative, respectively, of the data at point y. Solving equation (4) for the matrix of \overline{a}:

\overline{a}={\overline{x}^{T}\overline{x}}⁻¹\overline{x}^{T}\overline{y}. (5)

Note that the matrix {\overline{x}^{T}\overline{x}}⁻¹\overline{x}^{T} depends only on the order of the polynomial and the filter width, and not on the data \overline{y}. This means that the matrix {\overline{x}^{T}\overline{x}}⁻¹\overline{x}^{T} can be calculated once for a given polynomial order and filter width, and used repeatedly. This observation makes the Savitsky-Golay filtering technique fast and efficient for automated use.

The output from a SVG peak extraction routine typically consists of an array of data triplets, each data triplet consisting of the measured wavelength, intensity, and width of the peak. The array can contain more or fewer data triplets depending on the number of peaks detected. However, the array of data comprising data triplets can be substantially smaller in size than the original set of data used to extract peak information.

A typical process run on a plasma etch system consists of a series of steps, each step lasting from 1 to 180 seconds. During each step, process gas flow rates, RF power, and other process input variables can be controlled. Particular parameters measured over time tend to show the effect of changing the process variables as a series of steps reflecting the change in the measured parameter between steps. During a step, the measured parameters tend to be relatively constant reflecting the variation of the input parameters, fluctuation in pressure, temperature and other processes occurring inside the plasma chamber. In addition, as the plasma etch removes one type of material and exposes another type of material, the chemical composition of the plasma changes which gives rise to changes in the optical emission spectra. One possible spectra change is the appearance or disappearance of characteristic emission lines belonging to materials that are or are not currently exposed to the plasma.

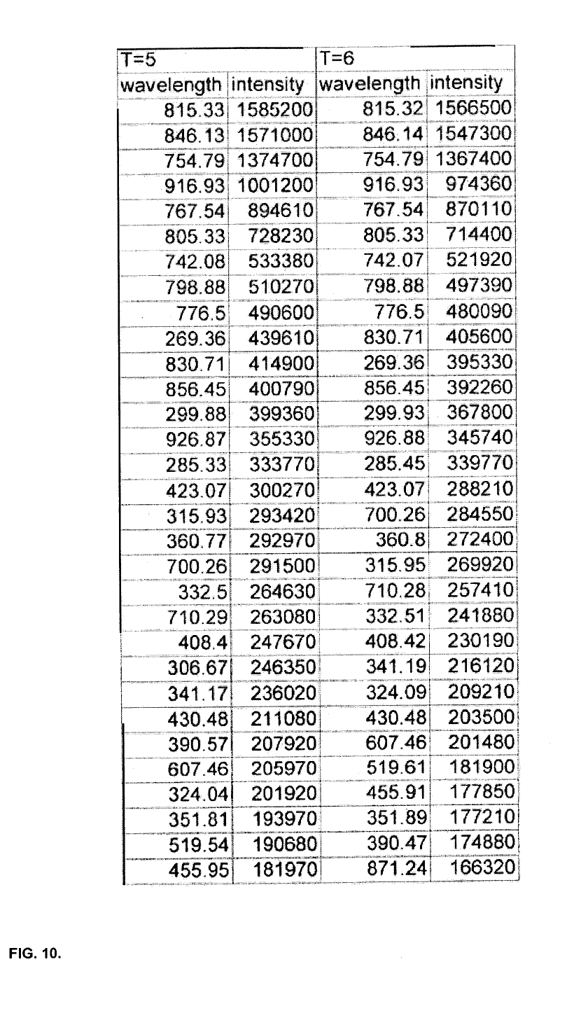

A partial listing of the peaks from a typical process run, extracted using SVG, is presented in FIG. 10. At the beginning of the process run, only a few peaks were detected, largely due to the low power of the processing step. Later in the process, the number of detected peaks and their intensity increased. Toward the end of the run, the spectral signature changed, largely due to the change in the chemical composition of the plasma. In the table of FIG. 10, wavelength and intensity for two consecutive time periods “T=5” and “T=6” are presented. Notice the relative intensities of peaks at various wavelengths changes causing the entries to appear in a different sort order. However, for this list of peaks, each wavelength appears in both lists.

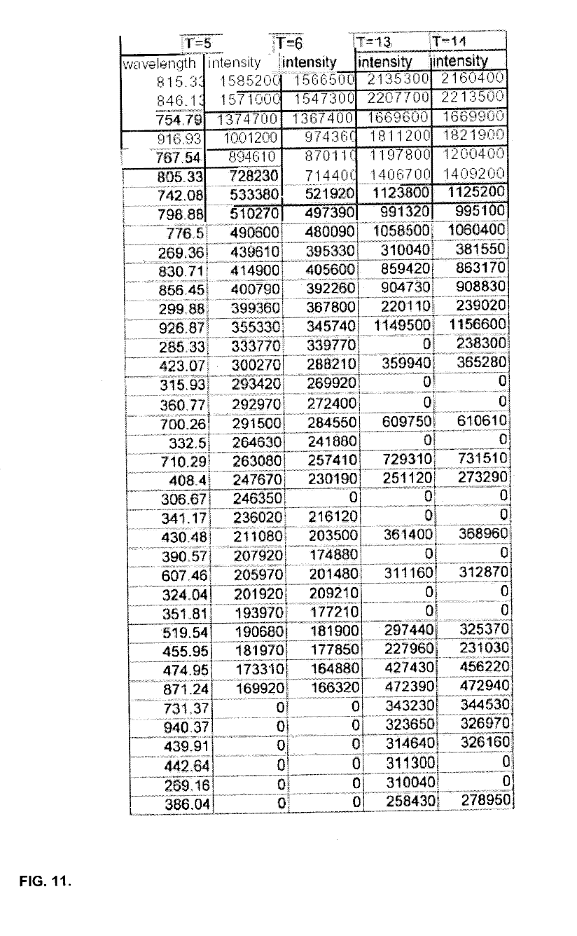

An adaptive spectral signature based on the union of all wavelengths from a process run can be formulated by placing peaks that occur at the same wavelength or very close to the same wavelength in a separate row in the combined output table. In this case, each row refers to a particular wavelength bin, and each column refers to a particular measurement period. As new wavelengths are detected, a new row is placed in the table. This concept is illustrated in the table of FIG. 11. The table of FIG. 11 exemplifies how careful pre-processing of data can dramatically reduce the volume of data to be transferred from one place to another, processed, and stored and, hence, form a reduced data set capable of characterizing the plasma processing system. One example of this pre-processing step has been the extraction of peak parameters, such as position (or wavelength), intensity and width.

SVG filtering is well known to those skilled in the art and algorithms are commercially available such as that which is published in Numerical Recipes in C, Press et al., Cambridge University Press, pp. 650 ff.

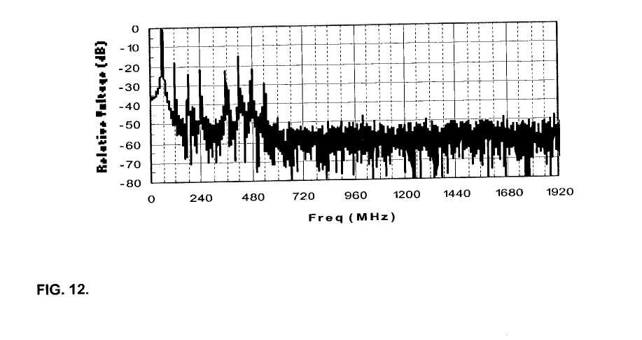

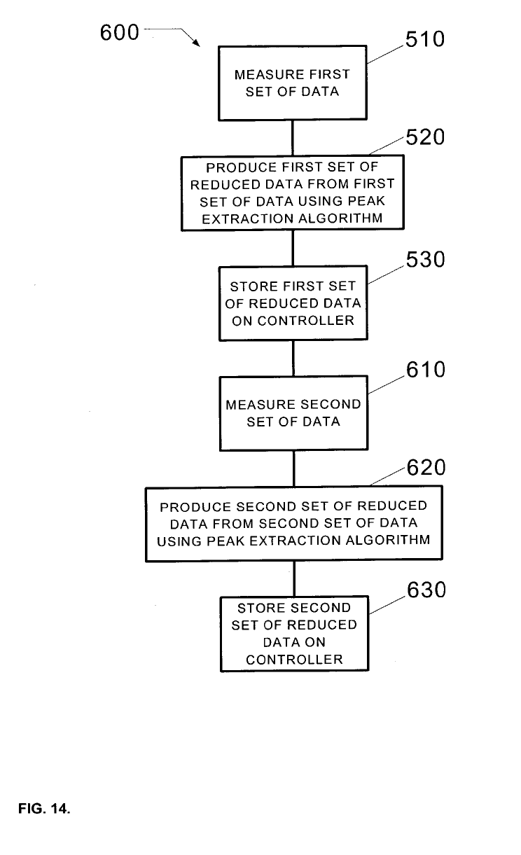

In an alternate embodiment, an exemplary RF spectrum from a RF measurement, performed by inserting a loop antenna within a RF transmission line, is presented in FIG. 12. In FIG. 12, a plurality of identifiable peaks are observed that are associated with the fundamental RF frequency (excitation frequency) and harmonics (2^{nd}, 3^{rd}, . . . ) of the excitation frequency. When multiple excitation frequencies are employed (e.g. 60 MHz and 2 MHz), the spectrum can include harmonic frequencies related to the multiple excitation frequencies and inter-modulation products of the multiple excitation frequencies. As before, the set of data reported in FIG. 14 can be processed, using SVG filtering techniques, yielding a reduced set of data describing the RF peaks (or harmonics).

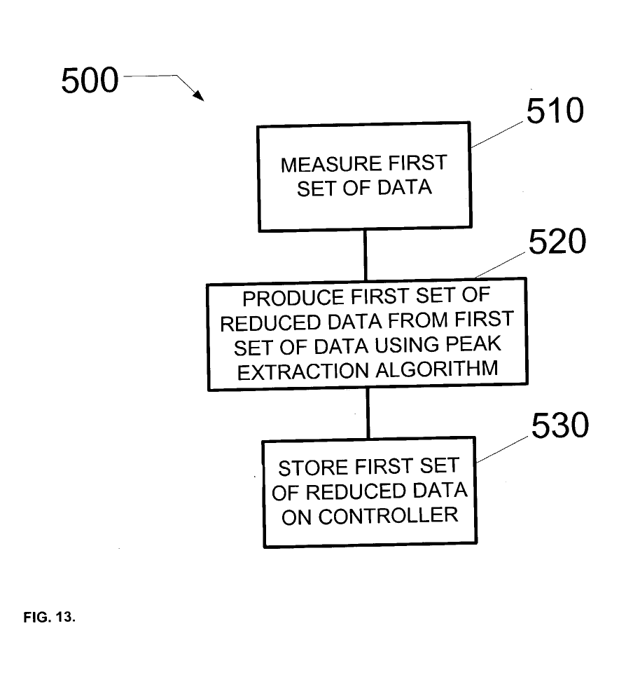

An improved method of data handling, storage, and manipulation for a plasma processing system is now described in reference to FIG. 13. A flow chart describing procedure 500 is presented in FIG. 13, and procedure 500 begins in 510. In 510, a first set of data is measured using a measurement device coupled to a process reactor. The first set of data can, for example, correspond to a first time or a first substrate. As described above, the measurement device can be, for example, a light detection device (e.g. spectrometer, monochromator, optical device including a detector, an optical filter, a grating and/or a prism, etc.), or an electrical measurement device (e.g. a voltage probe, a current probe, a power meter, an external RF antenna, etc.). In general, the first set of data can be a data trace exhibiting identifiable “peaks” having physical meaning associated with the process occurring in the plasma processing system. For example, the data trace can be a light spectrum or a RF spectrum.

In 520, a first set of reduced data is produced from the first set of data acquired from the process reactor using a peak extraction algorithm. As discussed above, the peak extraction algorithm can be, for example, a Savitsky-Golay filter. In one embodiment, the data reduction using a peak extraction algorithm provides at least one of a peak position (e.g. wavelength, wavenumber, frequency, radian frequency, phase, etc.), a peak intensity (e.g. light intensity, RF voltage harmonic, RF current harmonic, harmonic of radiated harmonic power, RF power harmonic, etc.), and a peak width (e.g. peak full width half maximum, etc.) associated with the identifiable peaks observed in the first set of data. In 530, the first set of reduced data is stored.

In an alternate embodiment, an improved method of data handling, storage and manipulation for a plasma processing system is described in reference to FIG. 14. A procedure 600 describing the method is presented in FIG. 14 beginning with 510 through 530 as described above and followed by 610 wherein a second set of data is measured using a measurement device coupled to a process reactor. The second set of data can, for example, correspond to a second time or a second substrate. As described above, the measurement device can be, for example, a light detection device (e.g. spectrometer, monochromator, optical device including a detector, an optical filter, a grating and/or a prism, etc.), or an electrical measurement device (e.g. a voltage probe, a current probe, a power meter, an external RF antenna, etc.). In general, the second set of data can be a data trace exhibiting identifiable “peaks” having physical meaning associated with the process occurring in the plasma processing system. For example, the data trace can be a light spectrum or a RF spectrum.

In 620, a second set of reduced data is produced from the second set of data acquired from the process reactor using a peak extraction algorithm. As discussed above, the peak extraction algorithm can be, for example, a Savitsky-Golay filter. In one embodiment, the data reduction using a peak extraction algorithm provides at least one of a peak position (e.g. wavelength, wavenumber, frequency, radian frequency, phase, etc.), a peak intensity (e.g. light intensity, RF voltage harmonic, RF current harmonic, harmonic of radiated harmonic power, RF power harmonic, etc.), and a peak width (e.g. peak full width half maximum, etc.) associated with the identifiable peaks observed in the second set of data. In step 630, the second set of reduced data is stored.

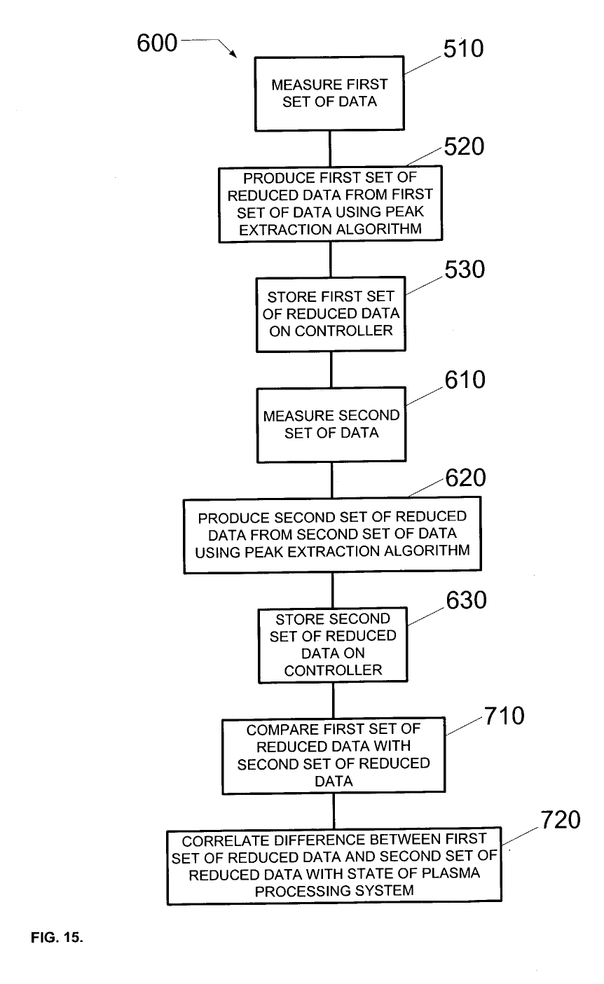

In an alternate embodiment, an improved method of data handling, storage and manipulation for a plasma processing system is described in reference to FIG. 15. In FIG. 15, procedure 600 (from FIG. 14) further describes the method continuing with 710 wherein a first set of reduced data is compared with a second set of reduced data. The comparison can, for example, comprise a determination of at least one difference between the first set of reduced data and the second set of reduced data. For instance, this difference can comprise a difference between a peak intensity of the first set of reduced data and a peak intensity of the second set of reduced data at substantially the same peak position (or wavelength).

In 720, the comparison of the first set of reduced data and the second set of reduced data is utilized to determine a state of the plasma processing system. For example, the at least one difference between the first set of reduced data and the second set of reduced data can be compared to a target value wherein, when the difference exceeds the target value, then a state of the plasma processing system is determined. The state of the plasma processing system can comprise an endpoint condition such as, for example, an endpoint of an etch process, or a fault condition such as, for example, a fault detected in the plasma processing system.

In an embodiment of the present invention, the improved method for data handling, storage and manipulation is executed in real-time utilizing data acquired in real time. For example, acquired data can be converted to form reduced data and, thereafter, the reduced data can be stored on a storage device without having stored the acquired data in anything but memory. In an alternate embodiment, the method is executed utilizing previously stored data. For example, the acquired data can be stored on a storage device and either the same processor or a different processor can convert the data at a later time to form reduced data, and then store the reduced data on either storage device. In an alternate embodiment, data can be acquired in parallel and converted to reduced data in parallel.

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An improved plasma processing system comprising:
a process reactor; and
a data collection system, said data collection system comprising a measurement device coupled to said process reactor and a controller coupled to said measurement device, wherein said controller provides an algorithm for improving handling, storage and manipulation of data extracted from said measurement device.

2. The plasma processing system as recited in claim 1, wherein said measurement device is at least one of a light detection device and an electrical measurement device.

3. The plasma processing system as recited in claim 2, wherein said light detection device comprises at least one of a detector, an optical filter, a grating, and a prism.

4. The plasma processing system as recited in claim 2, wherein said light detection device is at least one of a spectrometer and a monochromator.

5. The plasma processing system as recited in claim 2, wherein said electrical measurement device is at least one of a voltage probe, a current probe, an external RF antenna, and a power meter.

6. The plasma processing system as recited in claim 1, wherein said improving handling, storage and manipulation of data comprises reducing the volume of said data to reduced data for characterizing said plasma processing system.

7. The plasma processing system as recited in claim 6, wherein said reduced data comprises at least one of a peak position, a peak intensity, and a peak width.

8. The plasma processing system as recited in claim 7, wherein said peak position is at least one of a wavelength, a wavenumber, a frequency, a radian frequency, a phase, and an energy level.

9. The plasma processing system as recited in claim 7, wherein said peak intensity is at least one of a light intensity, a RF voltage harmonic, a RF current harmonic, a harmonic of radiated RF power, and a RF power harmonic.

10. The plasma processing system as recited in claim 7, wherein said peak width is a peak full width half maximum.

11. The plasma processing system as recited in claim 1, wherein said algorithm for improving handling, storage and manipulation of data comprises a peak extraction algorithm.

12. The plasma processing system as recited in claim 11, wherein said peak extraction algorithm is a Savitsky-Golay filter.

13. The plasma processing system as recited in claim 11, wherein an output of said peak extraction algorithm is at least one of a peak position, a peak intensity, and a peak width.

14. The plasma processing system as recited in claim 13, wherein said peak position is at least one of a wavelength, a wavenumber, a frequency, a radian frequency, a phase, and an energy level.

15. The plasma processing system as recited in claim 13, wherein said peak intensity is at least one of a light intensity, a RF voltage harmonic, a RF current harmonic, and a RF power harmonic.

16. The plasma processing system as recited in claim 7, wherein said peak width is a peak full width half maximum.

17. An improved method of data handling, storage and manipulation for a plasma processing system, the method comprising:
measuring a first set of data using a measurement device coupled to a process reactor;
producing a first set of reduced data from said first set of data using a peak extraction algorithm executed on a controller, said controller coupled to said measurement device, wherein said first set of reduced data comprises a data volume equal to or less than a data volume of said first set of data; and
storing said first set of reduced data on said controller.

18. The improved method of data handling, storage and manipulation as recited in claim 17, wherein said measurement device is at least one of a light detection device and an electrical measurement device.

19. The improved method of data handling, storage and manipulation as recited in claim 18, wherein said light detection device comprises at least one of a detector, an optical filter, a grating, and a prism.

20. The improved method of data handling, storage and manipulation as recited in claim 18, wherein said light detection device is at least one of a spectrometer and a monochromator.

21. The improved method of data handling, storage and manipulation as recited in claim 17, wherein said electrical measurement device is at least one of a voltage probe, a current probe, an external RF antenna, and a power meter.

22. The improved method of data handling, storage and manipulation as recited in claim 17, wherein said first data set comprises at least one of a light spectrum and a RF spectrum.

23. The improved method of data handling, storage and manipulation as recited in claim 17, wherein said first set of reduced data comprises at least one of a peak position, a peak intensity, and a peak width.

24. The improved method of data handling, storage and manipulation as recited in claim 23, wherein said peak position is at least one of a wavelength, a wavenumber, a frequency, a radian frequency, a phase, and an energy level.

25. The improved method of data handling, storage and manipulation as recited in claim 23, wherein said peak intensity is at least one of a light intensity, a RF voltage harmonic, a RF current harmonic, a harmonic of radiated RF power, and a RF power harmonic.

26. The improved method of data handling, storage and manipulation as recited in claim 23, wherein said peak width is a peak full width half maximum.

27. The improved method of data handling, storage and manipulation as recited in claim 17, wherein said peak extraction algorithm is a Savitsky-Golay filter.

28. The improved method of data handling, storage and manipulation as recited in claim 27, wherein an output of said peak extraction algorithm is at least one of a peak position, a peak intensity, and a peak width.

29. The improved method of data handling, storage and manipulation as recited in claim 27, wherein said peak position is at least one of a wavelength, a wavenumber, a frequency, a radian frequency, a phase, and an energy level.

30. The improved method of data handling, storage and manipulation as recited in claim 27, wherein said peak intensity is at least one of a light intensity, a RF voltage harmonic, a RF current harmonic, and a RF power harmonic.

31. The improved method of data handling, storage and manipulation as recited in claim 27, wherein said peak width is a peak full width half maximum.

32. An improved method of data handling, storage and manipulation as recited in claim 17, said method further comprising:
measuring a second set of data using a measurement device coupled to a process reactor;
producing a second set of reduced data from said second set of data using a peak extraction algorithm executed on a controller, said controller coupled to said measurement device, wherein said second set of reduced data comprises a data volume equal to or less than a data volume of said second set of data; and
storing said second set of reduced data on said controller.

33. An improved method of data handling, storage and manipulation as recited in claim 32, wherein said measuring said second set of data corresponds to a second period in time and said measuring said first set of data corresponds to a first period of time.

34. An improved method of data handling, storage and manipulation as recited in claim 32, said method further comprising:
comparing said first set of reduced data with said second set of reduced data; and
correlating said comparing of said first set of reduced data and said second set of reduced data with a state of said plasma processing system.

35. An improved method of data handling, storage and manipulation as recited in claim 34, wherein said comparing said first set of reduced data with said second set of reduced data comprises determining at least one difference between said first set of reduced data and said second set of reduced data.

36. An improved method of data handling, storage and manipulation as recited in claim 35, wherein said at least one difference between said first set of reduced data and said second set of reduced data comprises a difference in at least one of a peak intensity, a peak width, and a peak position.

37. An improved method of data handling, storage and manipulation as recited in claim 35, wherein said correlating said comparing of said first set of reduced data and said second set of reduced data with a state of said plasma processing system comprises relating said at least one difference between said first set of reduced data and said second set of reduced data to a target value.

38. An improved method of data handling, storage and manipulation as recited in claim 34, wherein said state of said plasma processing system comprises at least one of an endpoint condition and a fault condition.

39. An improved method of data handling, storage and manipulation as recited in claim 37, wherein said state of said plasma processing system comprises at least one of an endpoint detection and a fault detection when said at least one difference between said first set of reduced data and said second set of reduced data exceeds said target value.

40. An improved data collection system comprising:
a measurement device; and
a controller coupled to said measurement device, wherein said controller provides an algorithm for improving handling, storage and manipulation of data extracted from said measurement device.

41. The improved data collection system as recited in claim 40, wherein said measurement device is at least one of a light detection device and an electrical measurement device.

42. The improved data collection system as recited in claim 41, wherein said light detection device comprises at least one of a detector, an optical filter, a grating and a prism.

43. The improved data collection system as recited in claim 41, wherein said light detection device is at least one of a spectrometer and a monochromator.

44. The improved data collection system as recited in claim 41, wherein said electrical measurement device is at least one of a voltage probe, a current probe, an external RF antenna, and a power meter.

45. The improved data collection system as recited in claim 40, wherein said improving handling, storage and manipulation of data comprises reducing the volume of said data to reduced data for characterizing said plasma processing system.

46. The improved data collection system as recited in claim 45, wherein said reduced data comprises at least one of a peak position, a peak intensity, and a peak width.

47. The improved data collection system as recited in claim 46, wherein said peak position is at least one of a wavelength, a wavenumber, a frequency, a radian frequency, a phase, and an energy level.

48. The improved data collection system as recited in claim 46, wherein said peak intensity is at least one of a light intensity, a RF voltage harmonic, a RF current harmonic, a harmonic of radiated RF power, and a RF power harmonic.

49. The improved data collection system as recited in claim 46, wherein said peak width is a peak full width half maximum.

50. The improved data collection system as recited in claim 40, wherein said algorithm for improving handling, storage and manipulation of data comprises a peak extraction algorithm.

51. The improved data collection system as recited in claim 50, wherein said peak extraction algorithm is a Savitsky-Golay filter.

52. The improved data collection system as recited in claim 50, wherein an output of said peak extraction algorithm is at least one of a peak position, a peak intensity, and a peak width.

53. The improved data collection system as recited in claim 52, wherein said peak position is at least one of a wavelength, a wavenumber, a frequency, a radian frequency, a phase, and an energy level.

54. The improved data collection system as recited in claim 52, wherein said peak intensity is at least one of a light intensity, a RF voltage harmonic, a RF current harmonic, and a RF power harmonic.

55. The improved data collection system as recited in claim 52, wherein said peak width is a peak full width half maximum.
